(19) United States
(12) Patent Application Publication
(10) Pub. No.: US 2013/0007989 A1
(43) Pub. Date: Jan. 10, 2013

(54) PAPER CLIP WITH SHEET GRIPPING ENDS

(75) Inventor: Frank D. Werner, Teton Village, WY (US)

(73) Assignee: ORIGIN INC., Jackson, WY (US)

(21) Appl. No.: 13/176,840

(22) Filed: Jul. 6, 2011

(51) Int. Cl. B42F 1/04; B42F 1/02

(52) U.S. Cl. 24/67.9

(57) ABSTRACT

A paper clip is formed with a base length of wire and integral legs at opposite ends of the base length. The legs are bent so they cross at a location spaced from the base length and are resiliently contiguous where they cross. At least one of the outer end portions of the legs is bent in a direction so the outer tips of the legs will engage the opposite surfaces of a stack of sheets held between the legs.

### BACKGROUND OF THE DISCLOSURE

This disclosure relates to a high sheet capacity, secure, easily used paper clip that firmly grips the sheets, and has gripping legs or bars with sheet engaging ends that are bent toward the sheets being held. The ends of the sheet engaging or gripping legs do not tend to snag other loose sheets.

Paper clips at the present time come in various shapes and sizes. The most common clip is the “Gem” style clip, which has long been used. The Gem style clip is difficult to use with thick stacks of papers or sheets, and does not lie flat on the sheets when applied, so the ends will snag loose pages and other stacks of sheets held with paper clips. The Gem style clips also have a weak gripping force, and will tend to dimple the sheets being held.

A description of many prior art clips is in an article by Henry Petroski, entitled “The Evolution of Artifacts” in American Scientist, Vol. 80, September-October 1992, pages 416-420. The paper clips in the prior art that are made of bent wire have the undesirable effect of the ends of the paper clip legs or bars tend to snag other sheets. This is due to the end raising from the surface of the sheets being held when the paper clip in slid onto a stack of sheets.

### SUMMARY OF THE DISCLOSURE

The present disclosure relates to a paper clip made of a resilient wire that is formed into a shape with a spine or base section and two legs or bars that preferably cross and overlie each other at a location spaced from the spine. Each of the legs has an outer end portion that engages a surface of sheets to be clipped, with each leg on an opposite side surface from the other, such that the sheets to be held are trapped between and held by the resilient force of the legs tending to move together. At least one of the two outer ends of the legs are bent in a direction toward the sheet surface the respective leg engages so the outer ends will engage the sheet surface under it and remain on the surface so it is not likely to snag or drag other sheets not being held by the paper clip. Also, because of the bend of the legs toward the surface, the legs overlie will provide a resilient force to secure the sheets being held.

The paper clip of the present disclosure is easily formed and easy to place on a stack of sheets, such as paper sheets, easier that nearly all other designs.

### BRIEF DESCRIPTION OF THE DRAWINGS

FIG. 1 is a plan view of a paper clip made according to the present disclosure, shown in place on a stack of individual sheet, which are shown fragmentarily;

FIG. 2 is an end view of the paper clip in FIG. 1, showing a spine length;

FIG. 3 is a fragmentary side view of a leg of the paper clip in FIG. 1 and taken on line 3-3 in FIG. 1;

FIG. 4 is a fragmentary sectional view taken on line 4-4 in FIG. 1;

FIG. 5 is a sectional view taken on line 5-5 in FIG. 1; and

FIG. 6 is a plan view of a paper clip made according to the present disclosure with modified outer ends of the side legs.

### DESCRIPTION OF THE PREFERRED EMBODIMENTS

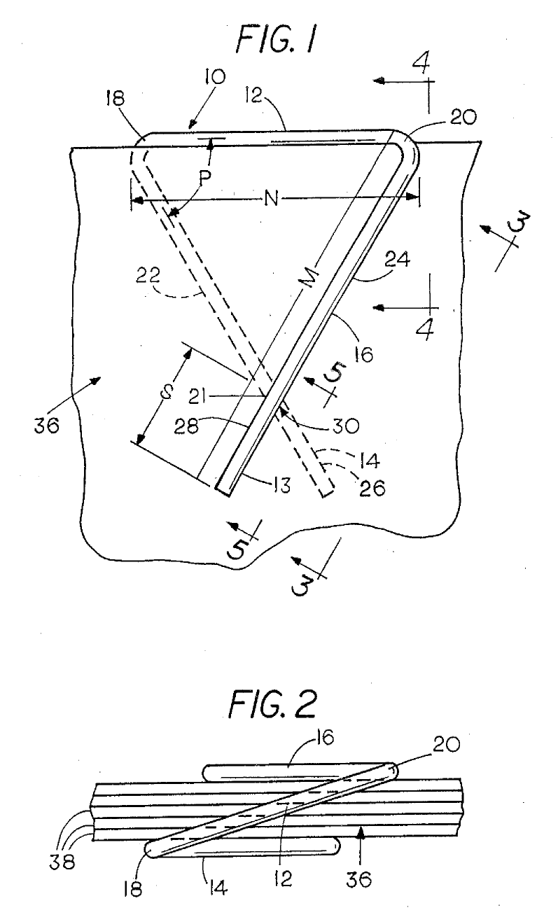

Referring to FIGS. 1 and 2, in particular, a paper clip 10 made according to the present disclosure is preferably formed from a single bar or wire and includes a spine or base length 12 that has integral legs or bars 14 and 16 extending therefrom and joined to the opposite ends of the base length 12 at bends 18 and 20. Each of the legs in turn has a base or inner straight length portion 22 and 24 and each leg has a selected length outer end portion 26 and 28, at least one of which is bent out of line from the inner straight length portions 22 and 24 that extend between the bends and the spine or base length 12. The bend regions between the inner straight length portions of the legs and the outer end portions are in the region shown at 30 for the leg 16, and would be at the same location on the leg 14. The legs are resiliently loaded together where they cross when no sheets are between the legs. At least one of the outer end portions 26 and 28 is bent toward the other, which means they are bent toward a plane passing through the axis of spine 12 and between the legs where the legs cross. At least one of the outer end portions 26 and 28 thus is bent toward the adjacent surface of sheets placed between the legs, though such bends toward the adjacent surface of sheets being held in both leg is preferred.

When a stack 36 of individual sheets 38 are to be held together, the paper clip 10 is placed on the sheets by separating the legs 14 and 16 with the end portions 26 and 28 on opposite sides of the sheets to be held. The paper clip is then slightly twisted and pushed onto the sheets until the sheets are as shown FIGS. 4 and 5. The spine or base length 12 rests against the edges of the sheets held. The outer end portions 26 and 28 of the legs are spring loaded toward each other so the outer end portions tightly engage the opposite surfaces of the stack 36 of sheets 38 and clamp the sheets together. The positioning of the sheets is shown in FIGS. 4 and 5, and as seen in FIG. 5, the sheets may deform around the legs 14 and 16 slightly for good gripping.

With the outer end portions of the legs bent to engage the surfaces of the sheets when installed as a clip, the tips of the end portions do not tend to snag other sheets. The outer ends of the legs do not tilt away from the sheet surfaces as occurs with the “Gem” type, and other types of clips.

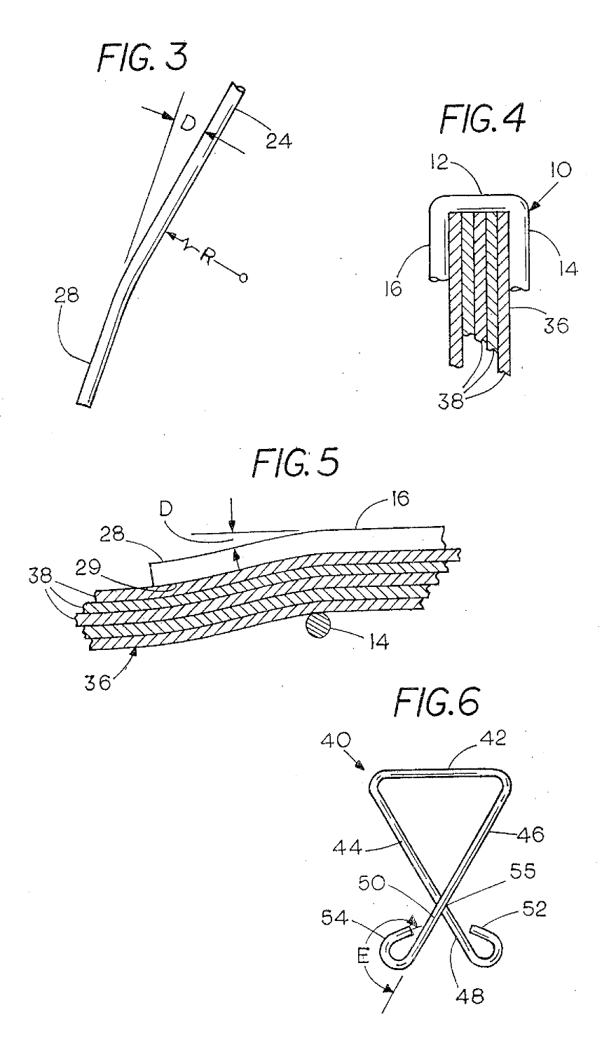

FIG. 6 illustrates a modified form of the outer ends or tips of the side legs or bars of a paper clip 40 made as previously described with a spine or base 42 having integral legs or bars 44 and 46 joined to the spine or base 42 at bends forming corners. The legs 44 and 46 cross as shown in FIG. 6 and have outer end portions 48 and 50 that are bent at an angle toward a reference plane passing along the longitudinal axis of the spine and between the legs so the outer end portions will be bent toward and engage sheets placed between the legs, as shown in FIG. 5. The outer end portions are bent toward the reference plane, with end portion 48 bent up and end portion 50 bent down, using bend angles as shown at D in FIG. 3. The bends of the outer portions may be made about where the legs 44 and 46 cross. To reduce sharp corners contacting the sheets, the outer tips of the outer end portion 48 and 50 are preferably rounded by having them bent back on themselves preferably between about 45 to substantially 180 degrees or more, and extremes are shown at E as being up to 270 degrees, and the bends could be even more. The rounding bends need not be circular. When bent 180 degrees or more the tip portions can be closed slightly and configured to form a relatively small diameter eye as shown at 52 and 54. The bends into an eye are made so the eye formed will lie flat on the paper. In other words the plane of the eye is approximately parallel to the sheet being held by the paper clip 40. The bends of the eyes form smoothly radiused or rounded ends on the outer end portions that engage the paper. The eye portions are also easier to grip and separate when the paper clip 40 is placed on a stack of sheets. It is apparent that the rounding or bend of the tips 52 and 54 could be bent up to 270 degrees in the opposite direction from what is shown.

Referring to FIG. 3, configurations applicable to both forms on the disclosure are indicated. The angle “D”, which is the angle of bend of the outer end portions relative to the plane of the sheet being held and as shown relative to the inner length portion of the respective leg, is generally in the range of 2 to 20 degrees or even more if the dimension S is small. The end portions 26 and 28 in FIG. 1 can be bent to have a radius R, which is shown in FIG. 3, and which radius is preferably about twice the length of the respective end portion 26 or 28, or may be a much smaller radius near the crossing point in the region shown at 30 in FIGS. 1 and 55 in FIG. 6, but straight beyond a short distance from that crossing point. The outer end portions 26 and 28, and 48 and 50, again are straight or somewhat curved lengths of the wire used to form the paper clip 10 or 40. The length of the outer end portions, shown at S, can be between 0.10 to 0.95 times M. In other words, between 10% and 95% of the leg length can be angled toward the sheets being held so the outer end tips of one or both legs engage the sheets. The outer tips of the outer end portions of the legs or bars of paper clip 40 are rounded, as shown, by forming the outer tip portions to be bent back onto themselves to reduce sharp corners. The ends of the legs 14 and 16 of the paper clip 10 can be deburred and flattened to reduce any scratching of the surface of a sheet being held. In FIG. 5, the outer end portion 28 of the leg or bar 16 may be flattened as shown at 29.

Suitable dimensions of the paper clip 10 or 40 are identified in FIG. 1. Suitable approximate values are as follows; Dimension N, the length of the spine or base, may be from 0.2 inches to 3 inches. The length of each leg is shown at M, and the ratio of N/M may be 0.1 to 3.0. The length of the outer end portions of the leg is shown at S, and the ratio S/M may be from 0.05 to 0.8. Angle P in FIG. 1 should be in the range of 20 to 80 degrees. The wire diameter is selectable to provide adequate clamping force for the sheets, but not so large as to be difficult to apply. The wire is preferably a spring wire of the type used in prior paper clips.

The legs of the paper clips shown are spring loaded against each other at rest, so that where the legs cross as shown at 21 in FIGS. 1 and 55 in FIG. 6, with no sheets in place the legs 14 and 16 and legs 44 and 46 should resiliently press firmly together.

The paper clips disclosed reduce the tendency of prior art paper clips to snag other loose sheets, especially when they are use on a rather thick group of sheets. The legs of the paper clips disclosed herein are easy to separate for insertion of the sheets, since the crossed legs provide ends for gripping, and the bends of the outer ends of the legs toward a plane where the sheets rest and thus toward the opposite sides of the sheets being held, provides a secure retaining force or action. A small twisting action makes application easier.

Although the present invention has been described with reference to preferred embodiments, workers skilled in the art will recognize that changes may be made in form and detail without departing from the spirit and scope of the invention.

1. A paper clip formed of a single length of wire comprising a straight spine length having a longitudinal axis, a first leg at a first end of the straight spine bent to form an included angle with the longitudinal axis of the straight spine between 20 and 80 degrees, a second leg at a second end of the straight spine bent to form an included angle with the longitudinal axis of the straight spine of between 20 and 80 degrees and crossing the first leg at a location spaced from the straight spine, the first and second legs being contiguous where they cross and under resilient loading together, the first and second legs having lengths extending outwardly from the location where the legs cross forming outer end portions bent toward a reference plane lying along the longitudinal axis of the straight spine and passing between the legs where the legs cross, the outer end portion of each of the legs having a tip portion bent to extend away from the other outer end portion at least 45 degrees with respect to other portions of the lengths of the respective outer end portion forming the bend, to form rounded ends on each outer end portion that extend outwardly from the respective outer end portion and each bent tip portion forming a plane generally parallel to the longitudinal axis of the straight spine.

2. (canceled)

3. (canceled)

4. The paper clip of claim 1, wherein both of the legs are straight between the spine and the location where the legs cross.

5. (canceled)

6. The paper clip of claim 1 further comprising the rounded ends bent between 45 degrees and 180 degrees to form the tip portions into eye shaped ends with the planes thereof generally parallel to the longitudinal axis of the straight spine.

7. A paper clip formed of a spring wire having a base length with a longitudinal axis and being bent at opposite ends of the base length to form first and second legs extending from the base length, the first and second legs crossing at a crossing location spaced laterally outwardly from the base length, the first and second legs being contiguous at the crossing location, the first and second legs having outer end portions extending away from the base length beyond the crossing location, the outer end portions inclining from axes of the legs adjacent the base length in a direction toward sheets placed between the legs, and the outer end portions comprising rounded bends forming eye shaped loops at tips of the outer end portions that have planes parallel to the longitudinal axis of the base length and that loop outwardly from the respective outer end portion to engage sheets placed between the legs and reduce snagging such sheets.

8. The paper clip of claim 7 further characterized by the outer end portions of at least one of the legs being bent at an angle of between 2 and 20 degrees relative to a plane of the axes of the legs adjacent the base length, with the bend being toward sheets placed between the legs.

9. The paper clip of claim 7 wherein the legs are bent relative to the base length between 20 and 80 degrees.

10. The paper clip of claim 9 wherein the base length is between 0.2 inches to 3 inches.

11. The paper clip of claim 8 wherein the outer end portions of the legs are bent at a bend radius of up to 0.9 times the length of the respective leg.

12. The paper clip of claim 10 wherein the legs have substantially the same length and a length of the base length divided by the length of a leg is between 0.1 and 3.0.

13. The paper clip of claim 12 wherein the outer end portion of each leg has a portion length from a center of the bend to a tip thereof, and the portion length divided by a length of the leg including such outer end portion is between 0.05 and 0.8.

14. (canceled)

15. A paper clip made from a single bar and having at least one base bar that in use is outside of sheets being clipped together, a pair of clamp bars, each clamp bar extending laterally outwardly from one of the opposite ends of the base bar, the base bar and the clamp bars being substantially in a plane, one of the clamp bars being positioned to be placed on one side of sheets being clipped together and a second clamp bar being positioned to be on an opposite side of sheets being clipped together, at least one of the clamp bars being bent toward the sheets being clipped together and crossing the other clamp bar, a bend location of the at least one clamp bar being between 0.10 and 0.95 times a length of the at least one clamp bar measured from the base bar to an outer end of the at least one clamp bar, and wherein outer tips of both of the clamp bars are rounded by bending the outer tips between 45 degrees and substantially 270 degrees relative to the respective clamp bar to form eye shaped loops with planes substantially along a bisecting plane of the paper clip parallel to the base bar, each loop extending to a side of the clamp bar on which the loop is formed in direction away from the other clamp bar.

16. (canceled)

17. (canceled)
